(19) United States
(12) Patent Application Publication
(10) Pub. No.: US 2009/0074285 A1
(43) Pub. Date: Mar. 19, 2009

(54) Surface inspection device

(75) Inventor: Yoshihiko Fujimori, Yokohuma-shi (JP)

Correspondence Address: MORGAN LEWIS & BOCKIUS LLP, 1111 PENNSYLVANIA AVENUE NW, WASHINGTON, DC, 20004, US

(73) Assignee: Nikon Corporation

(21) Appl. No.: 12/292,099

(22) Filed: Nov. 12, 2008

Related U.S. Application Data
(63) Continuation of application No. PCT/JP2007/060173, filed on May 11, 2007.

(30) Foreign Application Priority Data
May 15, 2006 (JP) 2006-135228

(51) Int. Cl. G06K 9/00

(52) U.S. Cl. 382/141

(57) ABSTRACT

A surface inspection device, including an illumination light source that irradiates a surface of a wafer with an inspection illumination light; a camera that receives a scattered light from the wafer irradiate with the inspection illumination light, and captures an image of the surface; a display device that displays the image of the wafer surface captured by an image sensing element of the camera; and an image expansion processing device that expands a portion having a high luminance in the image of the surface of the wafer captured by the image sensing element and causes the display device to display the expanded image.

This is a continuation of PCT International Application No. PCT/JP2007/060173, filed May 11, 2007, which is hereby incorporated by reference. This application also claims the benefit of Japanese Patent Application No. 2006-135228, filed in Japan on May 15, 2006, which is hereby incorporated by reference.

### TECHNICAL FIELD

The present invention relates to a surface inspection device that captures an image of the surface of an inspection target member (hereafter called “semiconductor wafer etc.”), such as a semiconductor wafer and liquid crystal display element panel (e.g. glass panel), using a camera (image capturing device), and inspects the surface based on the obtained image.

### TECHNICAL BACKGROUND

A semiconductor wafer etc. is comprised of many circuit element patterns on the surface, and if a defect exists on the surface, performance of a chip or a panel comprised of the circuit element patterns is diminished, so the inspection of surface defects is very important. Hence various devices have been used for inspecting the surface defects of a semiconductor wafer etc. This surface inspection device is constructed such that the surface of the semiconductor wafer or the like is irradiated with a predetermined inspection light (light appropriate for generating a reflected light, diffracted light and scattered light), the reflected light, diffracted light and scattered light from the surface are condensed by a condensing optical system, an image device (image sensing element) of a camera or the like is irradiated with this condensed light so as to form an image of the inspection target surface on an image receiving surface of the image device (capture an image by the camera having the image device), and based on the captured image, a pattern defect, unevenness of film thickness, scratches, adhesion of foreign substances, or the like, on the surface of the inspection target semiconductor wafer etc. are inspected (e.g. see Japanese Patent Application Laid-Open No. 2000-214099 and No. 2000-294609).

For example, a device that inspects a surface using a scattered light is mainly a device for inspecting scratches and the adhesion of dust on the surface of the semiconductor wafer etc., and is constructed such that when the wafer surface is irradiated with a light from the lateral direction at a shallow incident angle, the image of the wafer surface is captured by a camera installed at a position that does not receive regular reflection light or diffracted light of this incident light, and the scattered light from the wafer surface is detected. If a scratch or dust adhesion is present on the wafer surface, light contacted to the scratch or dust is reflected as scattered lights, and the camera images the scattered lights and captures an image having a bright spot at this position, hence the presence of a scratch or dust, and the locations thereof can be detected by this image.

### DISCLOSURE OF THE INVENTION

### Problems to be Solved by the Invention

When an image of the surface of a semiconductor wafer etc. is captured by such a camera and the surface defects are inspected, a scratch and dust (foreign substance) on a wafer fabricated via precision fabrication steps are so small that [the scratch and dust] are displayed as images of extremely fine bright lines a or as images of extremely small bright points b and c, for example, as shown in FIG. 2, and it is difficult to recognize the presence in an image that is displayed on a display unit. In FIG. 2, the rectangular area 16 is an image area of the display unit (display device), the circular image Wi is a captured image of a wafer, and each bright line a and bright points b and c show the presence of a scratch and dust on the wafer.

To solve this problem, an enlarged image could be displayed so as to display enlarged bright lines and bright points, but if an enlarged image is displayed, only a part of the wafer image Wi can be displayed on the image area 16, because of the limitation of the display screen, that is, the limitation of the image area 16, therefore even if the presence of a defect can be more easily recognized, confirming the general location of the defect on a semiconductor wafer etc. (inspection target member) becomes difficult.

With the foregoing in view, it is an object of the present invention to provide a surface inspection device that can easily confirm the presence of micro-scratches and foreign substances on the surface of an inspection target member, and the locations thereof.

### Means to Solve the Problems

To achieve this object, a surface inspection device of the present invention comprises: an illumination unit that irradiates a surface of an inspection target member with an inspection light; an image capturing unit that captures an image of the surface of the inspection target member irradiated with the inspection light from the illumination unit; a display unit that displays the image of the surface of the inspection target member captured by the image capturing unit; and an image expansion unit that expands a portion of which brightness or color is different from a background portion in the image of the surface of the inspection target member captured by the image capturing unit, and causes the display unit to display the expanded image.

In this surface inspection device, it is preferable that the display unit displays the different portion which has been expanded while displaying the entire inspection target member.

In the above surface inspection device, it is preferable that the image capturing unit is disposed at a position where irradiation of the inspection light from the illumination unit is received, and regular reflection light and diffracted light emitted from the surface of the inspection target member are not received, and captures an image based on a scattered light emitted from the surface of the inspection target member.

It is preferable that the above surface inspection device further comprises a display judgment unit that detects a portion in the image where brightness of the scattered light is a predetermined value or more, judges the portion as a defect, and causes the display unit to display the portion judged as a defect.

In the above surface inspection device, it is preferable that the image expansion unit expands the image of the portion judged as a defect, and causes the display unit to display the expanded image.

### ADVANTAGEOUS EFFECTS OF THE INVENTION

According to the surface inspection device of the present invention, the presence of such a defect as a scratch can be easily confirmed, and a position of the defect on the surface of the inspection target member can be easily confirmed.

### BRIEF DESCRIPTION OF THE DRAWINGS

FIG. 1 is a diagram depicting a configuration of a surface inspection device according to an embodiment of the present invention;

FIG. 2 is a front view depicting an example of an image based on scattered lights of a wafer, which is displayed on a screen when the expansion processing is not performed in the surface inspection device;

FIG. 3 is a flow chart depicting surface inspection steps by the surface inspection device;

FIG. 4 is a diagram depicting a simplified inspection image;

FIG. 5 is a diagram depicting a processing for expanding the above simplified inspection image by a template using a template, and an example of the template;

FIG. 6 is a diagram depicting a state when defects of the above simplified inspection image are expanded;

FIG. 7 is a diagram depicting a different example of the template;

FIG. 8 is a front view depicting an example of an image based on scattered lights of a wafer, which is displayed on a screen when the expansion processing is performed in the surface inspection device; and

FIG. 9 is a front view depicting another example of an image of a wafer based on scattered lights, which is displayed on a screen when the expansion processing is performed in the surface inspection device.

### DESCRIPTION OF THE PREFERRED EMBODIMENT

Preferred embodiments of the present invention will now be described with reference to the drawings. FIG. 1 shows an example of a surface inspection device according to the present invention, and this device detects surface defects (e.g. scratches, dust) of a semiconductor wafer W by scattered lights. This surface inspection device has a holder 2 for holding a wafer W, and the wafer W transported by a carrier device, which is not illustrated, is placed on the holder 2, and is secured by vacuum suction, for example.

This device further comprises: an illumination light source 1 that irradiates the surface of the wafer W secured to the holder 2 with an inspection illumination light Li at a small incident angle; a camera 5, that is disposed at a position where a regular reflection light Lo (1) and diffracted light Lo (2) are not received, from the surface of the wafer W, which has been irradiated with the inspection illumination light Li, and captures an image of the surface of the wafer W; an image processing device 10 that receives an image signal on the surface of the wafer W converted by an image sensing element (image device) 6 of the camera 5, and performs image processing; and a display device 15 that displays a wafer surface image processed by the image processing device 10. The image processing device 10 has a later mentioned image expansion processing device 11 (corresponding to the image expansion unit specified in the claims).

The surface inspection of the wafer W by this surface inspection device will now be described briefly. In order to perform inspection using this device, a wafer W to be an inspection target is transported to a predetermined position of the holder 2 by the carrier device, which is not illustrated, and the wafer W is suctioned and secured by the vacuum suction device built into the holder 2. Then the surface of the wafer W is irradiated with the inspection illumination light Li from the illumination light source 1. This inspection illumination light Li is reflected onto the surface of the wafer W, and the regular reflection light Lo (1) is emitted, as shown in FIG. 1. A circuit pattern is cyclically formed on the surface of the wafer W, and diffracted light Lo (2) is emitted onto the surface of the wafer W, as shown in FIG. 1, in a direction corresponding to the cycle pitch of the lines forming this circuit pattern and the wavelength of the inspection illumination light Li. Therefore, if an image of the surface of the wafer W is captured by a camera disposed at a position where the regular reflection light Lo (1) can be received, the surface inspection can be performed based on the regular reflection light, and if an image of the surface of the wafer W is captured by a camera disposed at a position where the diffracted light Lo (2) can be received, the surface inspection can be performed based on the diffracted light.

In the surface inspection device of the present embodiment, however, a camera 5 is disposed in a position where neither the regular reflection light Lo (1) nor the diffracted light Lo (2) is received, and the image of the surface of the wafer W is captured. If the image of the surface of the wafer W is captured by the image sensing element 6 of the camera 5 in this way, neither the regular reflection light Lo (1) nor the diffracted light Lo (2) enters the camera 5, so if the wafer W is normal, free of any scratches and the adhesion of dirt and dust on the surface, then the image displayed on the screen 16 of the display 15, after processing the image signal from the image sensing element 6 by the image processing device 10, is a black image with a part of the outer diameter portion of the wafer W as a contour.

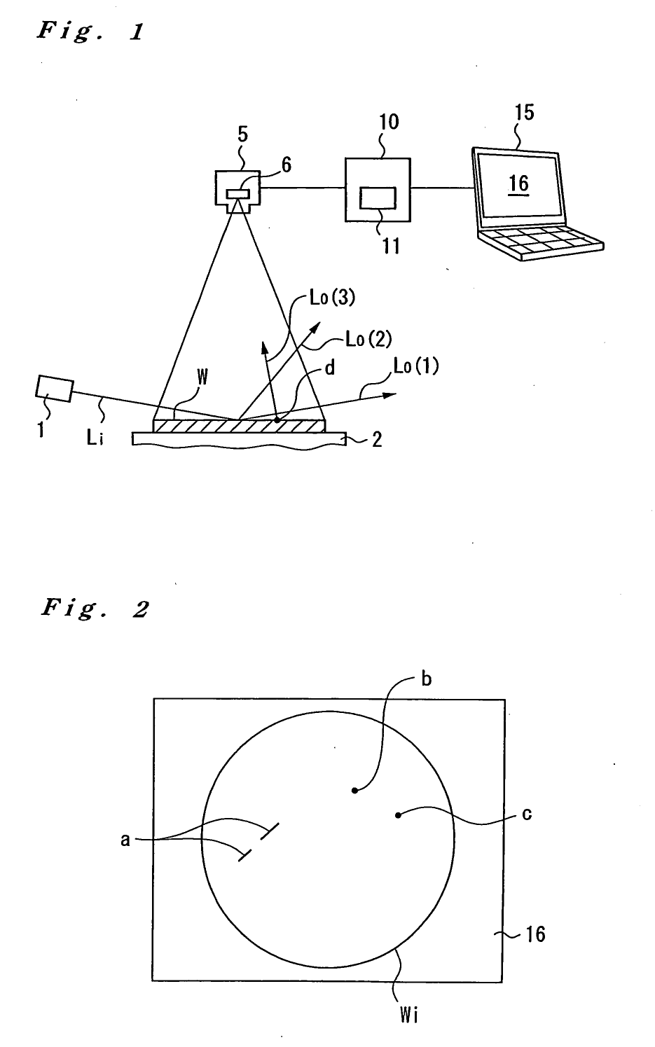

However, if a scratch (or dust) d, for example, exists on the surface of the wafer W, the inspection illumination light Li irradiated onto the scratch d is irregularly reflected, and a part of the irregular reflection light (scattered light) Lo (3) also enters the camera 5. As a result, the image displayed on the screen 16 of the display 15 after processing the image signals from the image sensing element 6 by the image processing device 10 shows bright lines a, which indicate scratches, and bright points b and c, which indicate the adhesion of dust, as shown in FIG. 2, by which the presence of scratches and dust on the wafer W can be detected. But, as described above, these bright lines a and bright points b and c are images captured by scattered lights of which quantity is low, and the scattered lights are due to extremely small scratches and dust, so the bright lines a and bright points b and c appear as extremely small lines and points in the image, therefore identifying the presence thereof is difficult, particularly with the naked eye.

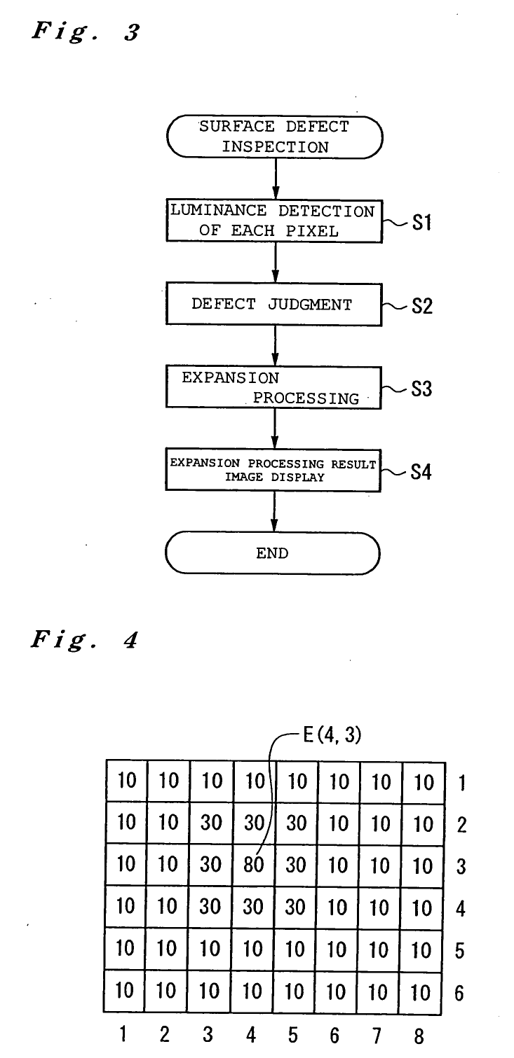

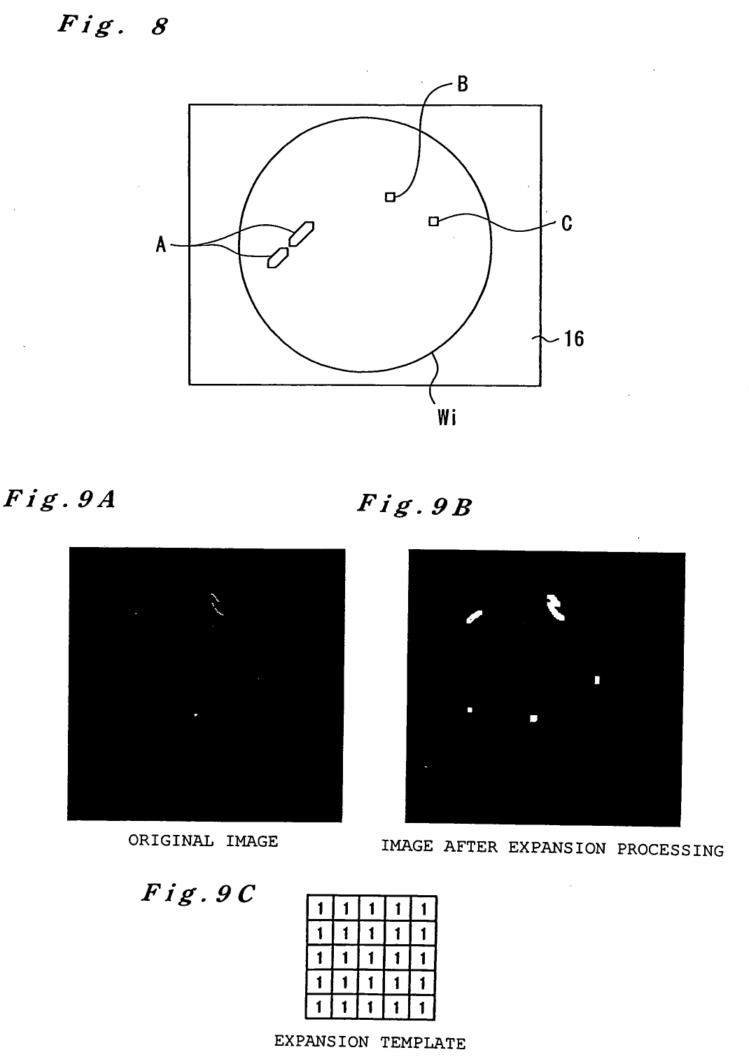

Hence the image processing device 10 has the image expansion processing device 11, by which only these bright lines a and bright points b and c are expanded, so that only the bright lines A and bright points B and C are expanded and displayed while the size of the wafer image Wi, acquired based on a part of the above mentioned outer diameter portion, remains the same, as shown in FIG. 8. The surface defect inspection using the surface inspection device according to the present embodiment, including the expansion display processing by the image expansion processing device 11 and the image processing by the image processing device 10, will now be described with reference to the flow chart in FIG. 3.

In this processing, the scattered light Lo (3) which entered the camera 5 is captured by the image sensing element 6, and is processed by the image processing device 10, and the luminance of each pixel of the image displayed on the screen 16 of the display 15 is detected (step S1). Then out of the luminance of each pixel detected in this way, pixels having a luminance higher than a predetermined luminance are judged as pixels having a defect (step S2). The pixel portion judged as a pixel indicating a defect in this way is displayed in color, such as red, and marked so that it is known that this portion has a defect. FIG. 2 shows an image displayed on the screen 16 of the display device 15. As FIG. 2 shows, the bright lines a and the bright points b and c, which correspond to scratches and dust, are displayed, and by the processing in step S2, these bright lines a and bright points b and c are colored, in red, for example.

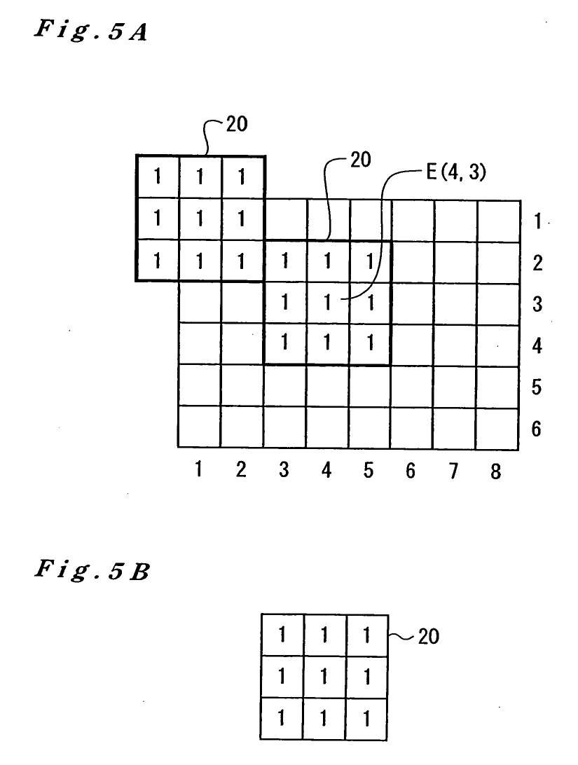

Then in step S3, a processing to expand the pixels (area) to indicate a defect is performed. This expansion processing is performed using an expansion processing template 20 shown in FIG. 5 (B), for example. Here, to simplify description, a simplified grayscale comprised of 8 pixels and 6 pixels, a total of 48 pixels, as shown in FIG. 4, is used, and the expansion processing using the template 20, in the case when the fourth pixel from the left and third from the top of this image (pixel E (4, 3)), is a pixel indicating a defect, is described. In FIG. 4, the numeric values written in each pixel position shows a luminance value of each pixel. In this example, the luminance in a portion where a defect does not exist (black level) is the luminance value 10, and the luminance become higher as this numeric value increases.

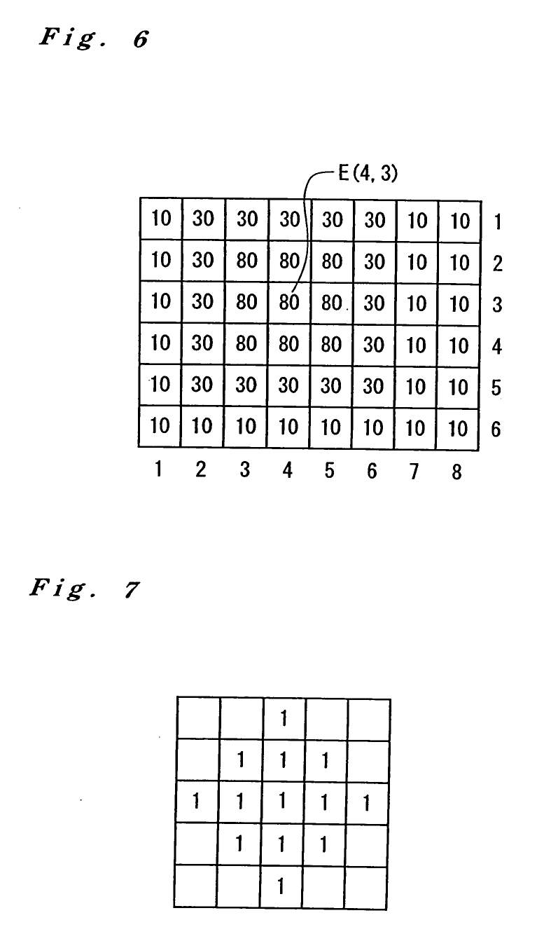

The expansion processing is performed by shifting the template 20 from the pixel position (1, 1) by one pixel at a time, as shown in FIG. 5 (A), until the entire image is scanned. And at each position where the template 20 is placed, the luminance value conversion processing is performed for each pixel of the image in FIG. 4. For the conversion processing, out of the pixels in the image in FIG. 4 corresponding to the pixels in the area covered by the template 20 (pixels where “1” is written in the template 20 in FIG. 5 (B)), the luminance value of the pixel of which illuminance is highest is used as the illuminance value of the pixel in the image after conversion which corresponds to the central pixel of the template 20 (a pixel second from the left and second from the top in FIG. 5 (B)), and this conversion processing is performed sequentially for the entire image in FIG. 4. As a result of this conversion processing, the converted image becomes as shown in FIG. 6. Then the converted image is displayed on the screen 16 of the display 15 (step S4). In FIG. 5, the number of pixels having the highest luminance value (pixel with luminance value 80) is 1, but in FIG. 6, the number of pixels with luminance value 80 is expanded to 3×3=9. Thus in the image converted by the above processing, the area of the defect portion is expanded while maintaining the information of the luminance values which indicate the degree of defects, and the general shape of the defect is also saved, so the defects can be very easily recognized in the image.

This expansion processing can be applied to both monochrome grayscale images and color images. If the input image is a monochrome image, the converted image thereof also becomes a monochrome image, and if the input image is a color image, the converted image thereof also becomes a color image. In the case of the inspection of scratches and dust, a monochrome image camera is generally used, but the inspection may be performed by a color image using a color image camera. In the case of a color image, the expansion processing using a template is performed in the same way, independently for each image of R (red component), G (green component) and B (blue component). This expansion processing can also be applied to a binary image (binary image of 0s and 1s, which indicate whether a defect is present or not).

FIG. 9 shows another processing example, which closely reflects an image actually captured. (A) is the image before processing, (B) is the image after processing, and (C) is a template used for the expansion processing. To make understanding easier, a binary image is used here. In the image before processing, there are five defective areas, that is, one line of a scratch, two lines of adjacent scratches, a micro point, a relatively large point, and two adjacent micro points. In the expanded image in (B), these defects are expanded and easily seen, and the differences in the shapes of the defects at the five locations can also be recognized. The adjacent two micro points are combined into one as a result of the expansion, but it can still be recognized that this part is more than just one micro point. The defect displayed at the upper right in FIG. 9 (B) looks like one defect, but is actually two defects combined. However, according to the shape thereof, it is easily judged that [this default] is based on the combination of two defects. In the case of the image (B), the defects can be clearly recognized even if the image must be reduced and displayed due to the size of the screen. In the case of a grayscale image, the luminance information is also added, and the pixels having the highest luminance are expanded, and the pixels having an intermediate luminance surround these pixels (see FIG. 6), whereby the luminance information is saved and enhanced, so [the defects] can be even more easily recognized.

In the case of a color image, a special meaning can be assigned to a color, such as red as a portion which is recognized as a defect, and if the above mentioned expansion processing is performed for the color image, a similar expansion effect can be provided to pixels corresponding to the color having the special meaning.

In the above description, the highest luminance value among the pixels in the image, corresponding to the pixels covered by the template, is used as the luminance value of the pixels after conversion, because this is effective in the case when the luminance of the defective portion is brighter (that is, luminance value is greater) than the peripheral area, but if the luminance of the defective portion is darker (that is, luminance value is smaller) than the peripheral area, the smallest luminance value can be used as the luminance value of the pixels after conversion, then a similar expansion effect can be provided to the dark portion which indicates a defect.

In the above description, the expansion processing using the template 20 having 9 pixels shown in FIG. 5 (B) was described, but the template may have more pixels. For examples, a rhombic template shown in FIG. 7, a polygonal template, a circular template and various other template shapes are possible, and the degree of expansion changes accordingly. The expansion processing of the template may be repeated a plurality of times, thereby expansion processing that further expands bright lines and bright points can be implemented.

As described above, according to the surface inspection device of the present embodiment, an image of a wafer surface captured by a camera is displayed on the display device, where a portion of which brightness or color is different from the background portion in the captured image is expanded by the expansion processing and displayed, so the presence of such defects as a scratch can be easily recognized, and the positions thereof on the wafer surface can also be easily confirmed while displaying an entire image of the wafer surface in the display area on the screen of the display device. To display such defects as a scratch on the surface, it is possible to encircle the defective portion with a square frame, for example, without expanding the image, but in this case, the location of the defect can be easily recognized, but the image of the defective portion is still small, and luminance and shape thereof are difficult to be known. The surface inspection device of the present embodiment can solve such a problem as well. Thus according to the surface inspection device of the present embodiment, the presence of micro foreign substances on a surface of such an inspection target member as a wafer, and the location, shape and luminance thereof can be easily confirmed.

In the above description, the defect inspection based on the scattered light from the wafer was described, but the present invention is not limited to this, but can be applied to performing expansion processing and displaying the image in a case where [defects] to be detected could be displayed only as a small image in the captured image of the inspection target.

What is claimed is:

1. A surface inspection device, comprising:
an illumination unit that irradiates a surface of an inspection target member with an inspection light;
an image capturing unit that captures an image of the surface of the inspection target member irradiated with the inspection light from the illumination unit;
a display unit that displays the image of the surface of the inspection target member captured by the image capturing unit; and
an image expansion unit that expands a portion of which brightness or color is different from a background portion in the image of the surface of the inspection target member captured by the image capturing unit, and causes the display unit to display the expanded image.

2. The surface inspection device according to claim 1, wherein the display unit displays the different portion which has been expanded while displaying the entire inspection target member.

3. The surface inspection device according to claim 1, wherein the image capturing unit is disposed at a position where irradiation of the inspection light from the illumination unit is received, and regular reflection light and diffracted light emitted from the surface of the inspection target member are not received, and captures an image based on a scattered light emitted from the surface of the inspection target member.

4. The surface inspection device according to claim 3, further comprising a display judgment unit that detects a portion in the image where brightness of the scattered light is a predetermined value or more, judges the portion as a defect, and causes the display unit to display the portion judged as a defect.

5. The surface inspection device-according to claim 1, wherein the image expansion unit expands the image of the portion judged as a defect, and causes the display unit to display the expanded image.

6. The surface inspection device according to claim 2, wherein the image capturing unit is disposed at a position where irradiation of the inspection light from the illumination unit is received, and regular reflection light and diffracted light emitted from the surface of the inspection target member are not received, and captures an image based on a scattered light emitted from the surface of the inspection target member.

7. The surface inspection device according to claim 6, further comprising a display judgment unit that detects a portion in the image where brightness of the scattered light is a predetermined value or more, judges the portion as a defect, and causes the display unit to display the portion judged as a defect.
